(19) United States
(12) Patent Application Publication
(10) Pub. No.: US 2015/0375475 A1
(43) Pub. Date: Dec. 31, 2015

(54) TEXTURED GLASS LAMINATES USING LOW-TG CLAD LAYER

(71) Applicant: CORNING INCORPORATED, Corning, NY (US)

(72) Inventor: Glen Bennett Cook, Elmira, NY (US)

(73) Assignee: CORNING INCORPORATED, Corning, NY (US)

(21) Appl. No.: 14/768,966

(22) PCT Filed: Mar. 17, 2014
(86) PCT No.: PCT/US14/30121

§ 371 Date: Aug. 19, 2015

Related U.S. Application Data
(60) Provisional application No. 61/804,862, filed on Mar. 25, 2013.

(51) Int. Cl. B32B 7/02; B32B 17/06; C03C 17/00

(52) U.S. Cl. CPC B32B 7/02; C03C 17/007; B32B 17/06; C03C 2217/478; B32B 2457/20; B32B 2457/12; B32B 2605/00; B32B 2419/00; C03C 2217/77; C03C 2217/78

(57) ABSTRACT

Textured glass laminates are described along with methods of making textured glass laminates. The textured glass laminates may be formed via addition of nanoparticles or manipulation of the glass surface. Laminate compositions are designed to take advantage of glass clad and core properties at Tg, annealing point, strain point, and or softening point, along with glass clad and core viscosities. The resulting compositions are useful for anti-reflection surfaces, anti-fingerprint surfaces, anti-fogging surfaces, adhesion-promoting surfaces, friction-reducing surfaces, and the like.

### CROSS REFERENCE TO RELATED APPLICATIONS

This application claims the benefit of priority under 35 U.S.C. §119 of U.S. Provisional Application Ser. No. 61/804,862 filed on Mar. 25, 2013 the content of which is relied upon and incorporated herein by reference it its entirety.

### BACKGROUND

The disclosure relates to textured surfaces on glass laminates and processes of making. More particularly, the disclosure relates to a glass laminate having a nano-textured surface.

Textured surfaces on glass have a variety of potential useful functions including include anti-reflection surfaces, anti-fingerprint surfaces, anti-fogging surfaces, adhesion-promoting surfaces, friction-reducing surfaces, and the like. In many cases a thermal forming or sintering step is useful to create all-inorganic textured surfaces because this enables the fabrication of robust surface textures that are “integral” with the glass bulk, leading to high mechanical durability. However, one drawback of thermal forming or sintering is the tendency of a glass sheet to undergo macroscopic bowing or warp at these high temperatures, especially for thin glass sheets. Thus there is a need for texturing methods and nano-texturing methods that carry the benefits of thermal forming or sintering, without the drawback of distorting the overall article or sheet shape.

### BRIEF SUMMARY

A first aspect comprises a glass laminate comprising a glass core having a first Tg, annealing point, strain point and a softening point; a glass clad having a second Tg, annealing point, strain point and a softening point; and optionally, a nanoparticulate layer; wherein the glass clad comprises a nano-textured surface; and wherein: i. the Tg of the glass clad is lower than the Tg of the glass core; ii. the annealing point of the glass clad is lower than the annealing point of the glass core; or iii. the softening point of the glass clad is lower than the softening point of the glass core; and wherein the CTE of the glass clad is lower than or equal to the CTE of the glass core.

In some embodiments of the glass laminate, the temperature difference between the Tg of the glass clad and the glass core, between the annealing point of the glass clad and the glass core, or the softening point of the glass clad and the glass core is greater than 20° C. In some embodiments, the temperature difference between the Tg of the glass clad and the glass core, between the annealing point of the glass clad and the glass core, or the softening point of the glass clad and the glass core is greater than 50° C. In some embodiments of the glass laminate, the temperature difference between the Tg of the glass clad and the glass core, between the annealing point of the glass clad and the glass core, or the softening point of the glass clad and the glass core is greater than 100° C. In some embodiments of the glass laminate, the temperature difference between the Tg of the glass clad and the glass core, between the annealing point of the glass clad and the glass core, or the softening point of the glass clad and the glass core is greater than 150° C.

In some embodiments of the glass laminate, the strain point of the glass core is higher than or equal to the annealing point of the glass clad. In some embodiments of the glass laminate, the viscosity of the glass core is 2× or greater the viscosity of the glass clad at the Tg of the glass clad or the viscosity of the glass core is 2× or greater the viscosity of the glass clad at the annealing point of the glass clad. In some embodiments of the glass laminate, the viscosity of the glass core is 5× or greater the viscosity of the glass clad at the Tg of the glass clad or the viscosity of the glass core is 5× or greater the viscosity of the glass clad at the annealing point of the glass clad. In some embodiments of the glass laminate, the viscosity of the glass core is 10× or greater the viscosity of the glass clad at the Tg of the glass clad or the viscosity of the glass core is 10× or greater the viscosity of the glass clad at the annealing point of the glass clad. In some embodiments of the glass laminate, the viscosity of the glass core is 20× or greater the viscosity of the glass clad at the Tg of the glass clad or the viscosity of the glass core is 20× or greater the viscosity of the glass clad at the annealing point of the glass clad.

In other embodiments, the difference in viscosity between the glass clad and glass core at the Tg of the glass clad gives a first ratio, R_{Tg}; the difference in viscosity between the glass clad and glass core at the forming temperature of the glass clad gives a second ratio, R_{F}; and wherein the value of R_{Tg}/R_{F} from 1.1 to 3.0. In some embodiments of the glass laminate, the difference in viscosity between the glass clad and glass core at the annealing point of the glass clad gives a first ratio, R_{A}; the difference in viscosity between the glass clad and glass core at the forming temperature of the glass clad gives a second ratio, R_{F}; and wherein the value of R_{A}/R_{F} from 1.1 to 3.0.

In some embodiments of the glass laminate, the glass core comprises: 55-75% SiO₂; 2-15% Al₂O₃; 0-12% B₂O₃; 0-18% Na₂O; 0-5% K₂O; 0-8% MgO; and 0-10% CaO, and wherein the total mol % (combined) of Na₂O, K₂O, MgO, and CaO is at least 10 mol %. In some embodiments of the glass laminate, the glass clad comprises: 65-85% SiO2; 0-5% Al₂O₃; 8-30% B₂O₃; 0-8% Na₂O; 0-5% K₂O; and 0-5% Li₂O, and wherein the total R₂O (alkali) is less than 10 mol %.

Another aspect comprises forming a glass laminate comprising a glass core having a first Tg, annealing point, strain point and a softening point; a glass clad having a second Tg, annealing point, strain point and a softening point; and optionally, a nanoparticulate layer; wherein the glass clad comprises a nano-textured surface; and wherein: i. the Tg of the glass clad is lower than the Tg of the glass core; ii. the annealing point of the glass clad is lower than the annealing point of the glass core; or iii. the softening point of the glass clad is lower than the softening point of the glass core; and wherein the CTE of the glass clad is lower than or equal to the CTE of the glass core, wherein the method comprises forming a glass laminate; and forming a nano-textured layer.

In some embodiments, the forming of the nano-textured layer is done at a temperature within 200° C. of the annealing point of the glass clad. In some embodiments, the forming a nano-textured layer comprises sintering nanoparticles onto the glass clad. In some embodiments, the nanoparticles have dimensions from about 100 nm to about 500 nm. In some embodiments, the nanoparticles comprise nanoclusters, nanopowders, nanocrystals, solid nanoparticles, nanotubes, quantum dots, nanofibers, nanowires, nanorods, nanoshells, fullerenes, and large-scale molecular components, such as polymers and dendrimers, and combinations thereof. In some embodiments, the nanoparticles comprise glass, ceramic, glass ceramic, polymer, metal, metal oxide, metal sulfide, metal selenide, metal telluride, metal phosphate, inorganic composite, organic composite, inorganic/organic composite, or combinations thereof.

These and other aspects, advantages, and salient features will become apparent from the following detailed description, the accompanying drawings, and the appended claims.

### BRIEF DESCRIPTION OF THE DRAWINGS

Referring to the drawings, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

FIG. 1 is a schematic view of a laminate with fused nano-particles on surface. The glass laminate comprises lower-Tg, lower-CTE clad layers along with a higher-Tg, higher-CTE clad layer, wherein in this embodiment the laminate has been coated by sintering a nanoparticle layer to one side. Note, the dimensions are not to scale.

FIG. 2 is a graph showing the contact angle on of oleic acid on a glass laminate (composition L) coated with a 250 nm silica nanoparticle monolayer of oleic acid as a function of material and processing conditions before and after durability tests.

FIG. 3 is a graph showing the contact angle on of oleic acid on a glass laminate (composition L) coated with a 100 nm silica nanoparticle monolayer of oleic acid as a function of material and processing conditions before and after durability tests.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements. Moreover, unless otherwise defined, all technical and scientific terms used herein have the same meaning as commonly understood by one of ordinary skill in the art to which this invention belongs. In case of conflict, the present specification, including the definitions herein, will control.

Although other methods and can be used in the practice or testing of the invention, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the invention be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

For the purposes of describing the embodiments, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the claimed invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

It is noted that one or more of the claims may utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

A first aspect comprises a textured glass laminate. Glass laminate, as used herein, describes combinations of two or more glass sheets or tubes that are thermally and/or chemically bonded together. In some embodiments, the glass sheets or tubes are formed and laminated through a fusion process, as described, for example, in U.S. Pat. Nos. 3,338,696, 6,990,834, and 6,748,765, all of which are incorporated by reference in their entirety. Multiple fusion-formed glass sheets or tubes may be combined using multiple isopipes to form laminates via a process as described in, for example, U.S. Pat. No. 8,007,913, incorporated by reference herein. Additional descriptions of laminate formation can be found in U.S. Pat. No. 4,214,886, U.S. application Ser. No. 13/479,701, U.S. Prov. Appl. No. 61/678,218, and PCT/US12/43299, all incorporated by reference in their entirety.

Other processes, such as off-line secondary (non-fusion) glass lamination, may also be used. In off-line processes, glass sheets can be cooled from the melt, then re-heated at a later point to form laminates, using rolling, pressing, vacuum molding, blow molding, or other methods. Thus, curved sheets (made using fusion or non-fusion processes) such as windows or eyeglasses, or even blown articles such as bottles or light bulb covers could be made in ways consistent with the invention.

The glass laminate comprises an outer “clad” layer and inner “core” layer, where the core layer is selected to have a higher glass transition temperature (“Tg”), softening, or annealing point than the clad layer(s), so the core maintains the overall flatness or shape of the glass sheet or article at elevated temperatures. The clad layer(s) has a relatively lower softening or annealing point, which facilitates the texturing of the surface at elevated temperatures, either through direct molding methods or through sintering of foreign inorganic nanoparticles to the surface.

The laminate may be asymmetric or symmetric. In some embodiments, the laminate has a symmetric, three-layered structure where the clad layers are the same thickness and composition, and where the clad layers not only have a lower Tg, softening temperature, or annealing temperature than the core, but the clad layers also have the same or (preferably) a lower CTE than the core, so that upon cooling, the clad layers are placed in compression. Alternatively, the laminate could be a asymmetric or be a 4-, 5-, 6-layer or higher-number-layer laminate, where the CTE's of the individual layers are chosen to produce beneficial compressive stress on the outer surface, and where the outer clad layers have a lower Tg, softening, or annealing temperature than one or more core layers.

As used herein, the glass clad comprises a glass layer that is fusion formable and has a Tg, softening, or annealing point, that is lower than the Tg, softening, or annealing point of the glass core it is being laminated with. In some cases the properties of the laminate can be defined by the glass transition temperatures (Tg's) of the layers of the laminate. Tg can be defined as the temperature at which the equilibrium viscosity of the glass-forming liquid is 10¹² P·s (equal to 10¹³ Poise).

In some embodiments, the glass clad can have a Tg of about 400° C. or greater, about 450° C. or greater, about 500° C. or greater, about 550° C. or greater, about 600° C. or greater, or about 650° C. or greater. In some embodiments, the glass clad has a Tg of from about 400 to about 800° C., about 450° C. to about 800° C., about 500° C. to about 800° C., about 550° C. to about 800° C., about 600° C. to about 800° C., about 650° C. to about 800° C., about 700° C. to about 800° C., about 750° C. to about 800° C., about 400 to about 700° C., about 450° C. to about 700° C., about 500° C. to about 700° C., about 550° C. to about 700° C., about 600° C. to about 700° C., about 650° C. to about 700° C., about 400° C. to about 650° C., about 450° C. to about 600° C., about 500° C. to about 650° C., about 550° C. to about 650° C., about 600° C. to about 650° C., about 400° C. to about 600° C., about 450° C. to about 600° C., about 500° C. to about 600° C., about 550° C. to about 600° C., about 400° C. to about 550° C., about 450° C. to about 550° C., about 500° C. to about 550° C., about 400° C. to about 500° C., about 450° C. to about 500° C., or about 400° C. to about 450° C.

In some embodiments, the glass core can have a Tg of about 550° C. or greater, about 600° C. or greater, about 650° C. or greater, about 700° C. or greater, about 750° C. or greater, about 800° C., about 850° C., or about 900° C. or greater. In some embodiments, the glass core has a Tg of from about 550° C. to about 1000° C., about 600° C. to about 1000° C., about 650° C. to about 1000° C., about 700° C. to about 1000° C., about 750° C. to about 1000° C., about 800° C. to about 1000° C., about 850° C. to about 1000° C., about 900° C. to about 1000° C., about 950° C. to about 1000° C., 550° C. to about 900° C., about 600° C. to about 900° C., about 650° C. to about 900° C., about 700° C. to about 900° C., about 750° C. to about 900° C., about 800° C. to about 900° C., about 850° C. to about 900° C., about 900° C. to about 900° C., 550° C. to about 850° C., about 600° C. to about 850° C., about 650° C. to about 850° C., about 700° C. to about 850° C., about 750° C. to about 850° C., about 800° C. to about 850° C., about 550° C. to about 800° C., about 600° C. to about 800° C., about 650° C. to about 800° C., about 700° C. to about 800° C., about 750° C. to about 800° C., about 550° C. to about 700° C., about 600° C. to about 750° C., about 60° C. to about 750° C., about 700° C. to about 750° C., about 550° C. to about 700° C., about 600° C. to about 700° C., about 650° C. to about 700° C., about 550° C. to about 650° C., about 600° C. to about 650° C., or about 550° C. to about 600° C.

In some embodiments, the difference between the clad Tg and core Tg is 20° C. or greater, 30° C. or greater, 40° C. or greater, 50° C. or greater, 60° C. or greater, 70° C. or greater, 80° C. or greater, 100° C. or greater, 125° C. or greater, 150° C. or greater, or 200° C. or greater.

Tg is generally close to the annealing point of the glass. This definition of Tg is independent of glass thermal history. However, since it can be difficult to directly measure a true equilibrium Tg, it is still useful in some cases to use the concepts of annealing, softening, and strain point temperatures, since these are directly measured by various known techniques.

In some embodiments, the glass clad can have an annealing point of about 400° C. or greater, about 450° C. or greater, about 500° C. or greater, about 550° C. or greater, about 600° C. or greater, or about 650° C. or greater. In some embodiments, the glass clad has an annealing point of from about 400 to about 800° C., about 450° C. to about 800° C., about 500° C. to about 800° C., about 550° C. to about 800° C., about 600° C. to about 800° C., about 650° C. to about 800° C., about 700° C. to about 800° C., about 750° C. to about 800° C., about 400 to about 700° C., about 450° C. to about 700° C., about 500° C. to about 700° C., about 550° C. to about 700° C., about 600° C. to about 700° C., about 650° C. to about 700° C., about 400° C. to about 650° C., about 450° C. to about 600° C., about 500° C. to about 650° C., about 550° C. to about 650° C., about 600° C. to about 650° C., about 400° C. to about 600° C., about 450° C. to about 600° C., about 500° C. to about 600° C., about 550° C. to about 600° C., about 400° C. to about 550° C., about 450° C. to about 550° C., about 500° C. to about 550° C., about 400° C. to about 500° C., about 450° C. to about 500° C., or about 400° C. to about 450° C.

In some embodiments, the glass core can have an annealing point of about 550° C. or greater, about 600° C. or greater, about 650° C. or greater, about 700° C. or greater, about 750° C. or greater, about 800° C., about 850° C., or about 900° C. or greater. In some embodiments, the glass core has an annealing point of from about 550° C. to about 1000° C., about 600° C. to about 1000° C., about 650° C. to about 1000° C., about 700° C. to about 1000° C., about 750° C. to about 1000° C., about 800° C. to about 1000° C., about 850° C. to about 1000° C., about 900° C. to about 1000° C., about 950° C. to about 1000° C., 550° C. to about 900° C., about 600° C. to about 900° C., about 650° C. to about 900° C., about 700° C. to about 900° C., about 750° C. to about 900° C., about 800° C. to about 900° C., about 850° C. to about 900° C., about 900° C. to about 900° C., 550° C. to about 850° C., about 600° C. to about 850° C., about 650° C. to about 850° C., about 700° C. to about 850° C., about 750° C. to about 850° C., about 800° C. to about 850° C., about 550° C. to about 800° C., about 600° C. to about 800° C., about 650° C. to about 800° C., about 700° C. to about 800° C., about 750° C. to about 800° C., about 550° C. to about 700° C., about 600° C. to about 750° C., about 60° C. to about 750° C., about 700° C. to about 750° C., about 550° C. to about 700° C., about 600° C. to about 700° C., about 650° C. to about 700° C., about 550° C. to about 650° C., about 600° C. to about 650° C., or about 550° C. to about 600° C.

In some embodiments, the difference between the clad annealing point and core annealing point is 20° C. or greater, 30° C. or greater, 40° C. or greater, 50° C. or greater, 60° C. or greater, 70° C. or greater, 80° C. or greater, 100° C. or greater, 125° C. or greater, 150° C. or greater, or 200° C. or greater.

In some embodiments, the glass clad can have a softening point of about 550° C. or greater, about 600° C. or greater, about 650° C. or greater, about 700° C. or greater, about 750° C. or greater, about 800° C. or greater, about 850° C. or greater, or about 900° C. or greater. In some embodiments, the glass clad has a annealing point of from about 550° C. to about 1000° C., about 600° C. to about 1000° C., about 650° C. to about 1000° C., about 700° C. to about 1000° C., about 750° C. to about 1000° C., about 800° C. to about 1000° C., about 850° C. to about 1000° C., about 900° C. to about 1000° C., about 950° C. to about 1000° C., 550° C. to about 900° C., about 600° C. to about 900° C., about 650° C. to about 900° C., about 700° C. to about 900° C., about 750° C. to about 900° C., about 800° C. to about 900° C., about 850° C. to about 900° C., about 900° C. to about 900° C., 550° C. to about 850° C., about 600° C. to about 850° C., about 650° C. to about 850° C., about 700° C. to about 850° C., about 750° C. to about 850° C., about 800° C. to about 850° C., about 550° C. to about 800° C., about 600° C. to about 800° C., about 650° C. to about 800° C., about 700° C. to about 800° C., about 750° C. to about 800° C., about 550° C. to about 700° C., about 600° C. to about 750° C., about 60° C. to about 750° C., about 700° C. to about 750° C., about 550° C. to about 700° C., about 600° C. to about 700° C., about 650° C. to about 700° C., about 550° C. to about 650° C., about 600° C. to about 650° C., or about 550° C. to about 600° C.

In some embodiments, the glass core can have a softening point of about 750° C. or greater, about 800° C. or greater, about 850° C. or greater, about 900° C. or greater, about 1000° C. or greater, about 1100° C. or greater, about 1200° C. or greater, or about 1300° C. or greater. In some embodiments, the glass core has a softening point of from about 700° C. to about 1300° C., about 800° C. to about 1300° C., about 700° C. to about 1300° C., about 800° C. to about 1300° C., about 900° C. to about 1300° C., about 1000° C. to about 1300° C., about 1100° C. to about 1300° C., about 1200° C. to about 1300° C., about 700° C. to about 1200° C., about 800° C. to about 1200° C., about 700° C. to about 1200° C., about 800° C. to about 1200° C., about 900° C. to about 1200° C., about 1000° C. to about 1200° C., about 1100° C. to about 1200° C., about 700° C. to about 1100° C., about 800° C. to about 1100° C., about 700° C. to about 1100° C., about 800° C. to about 1100° C., about 900° C. to about 1100° C., about 1000° C. to about 1100° C., about 700° C. to about 1000° C., about 800° C. to about 1000° C., about 700° C. to about 1000° C., about 800° C. to about 1000° C., about 900° C. to about 1000° C., about 700° C. to about 900° C., about 800° C. to about 900° C., or about 700° C. to about 800° C.

In some embodiments, the difference between the clad softening point and core softening point is 20° C. or greater, 30° C. or greater, 40° C. or greater, 50° C. or greater, 60° C. or greater, 70° C. or greater, 80° C. or greater, 100° C. or greater, 125° C. or greater, 150° C. or greater, 200° C. or greater, or 250° C. or greater.

In some embodiments, the glass clad can have a strain point of about 350° C. or greater, about 400° C. or greater, about 450° C. or greater, about 500° C. or greater, about 550° C. or greater, about 600° C. or greater, or about 650° C. or greater. In some embodiments, the glass clad has a strain point of from about 350° C. to 700° C., about 400 to about 700° C., about 450° C. to about 700° C., about 500° C. to about 700° C., about 550° C. to about 700° C., about 600° C. to about 700° C., about 650° C. to about 700° C., about 350° C. to about 650° C., about 400° C. to about 650° C., about 450° C. to about 600° C., about 500° C. to about 650° C., about 550° C. to about 650° C., about 600° C. to about 650° C., about 350° C. to about 600° C., about 400° C. to about 600° C., about 450° C. to about 600° C., about 500° C. to about 600° C., about 550° C. to about 600° C., about 350° C. to about 550° C., about 400° C. to about 550° C., about 450° C. to about 550° C., about 500° C. to about 550° C., about 350° C. to about 500° C., about 400° C. to about 500° C., about 450° C. to about 500° C., about 350° C. to about 450° C., about 400° C. to about 450° C., or about 350° C. to about 400° C.

In some embodiments, the glass core can have a strain point of about 500° C. or greater, about 550° C. or greater, about 600° C. or greater, about 650° C. or greater, about 700° C. or greater, about 750° C. or greater, or about 800° C. or greater. In some embodiments, the glass core has a strain point of from about 450° C. to 800° C., about 500 to about 800° C., about 550° C. to about 800° C., about 600° C. to about 800° C., about 650° C. to about 800° C., about 700° C. to about 800° C., about 750° C. to about 800° C., about 450° C. to about 750° C., about 500° C. to about 750° C., about 550° C. to about 700° C., about 600° C. to about 750° C., about 60° C. to about 750° C., about 700° C. to about 750° C., about 450° C. to about 700° C., about 500° C. to about 700° C., about 550° C. to about 700° C., about 600° C. to about 700° C., about 650° C. to about 700° C., about 450° C. to about 650° C., about 500° C. to about 650° C., about 550° C. to about 650° C., about 600° C. to about 650° C., about 450° C. to about 600° C., about 500° C. to about 600° C., about 550° C. to about 600° C., about 450° C. to about 550° C., about 500° C. to about 550° C., or about 450° C. to about 500° C.

In some embodiments, the difference between the clad strain point and core strain point is 20° C. or greater, 30° C. or greater, 40° C. or greater, 50° C. or greater, 60° C. or greater, 70° C. or greater, 80° C. or greater, 100° C. or greater, 125° C. or greater, 150° C. or greater, or 200° C. or greater. Some embodiments may include core-clad pairs where the core glass strain point temperature (sometimes defined as the temperature where the glass has a viscosity of 10^{14.68} Poise) is higher than the clad glass annealing temperature (sometimes defined as the temperature where the glass has a viscosity of 10¹³¹⁸ Poise). Many combinations from Table 1 meet this criteria, for example Glass M or Glass P (core layers) combined with Glass B or Glass G (clad layers). The specific definitions of strain and anneal point can vary somewhat. Also, the thermal history of the glass and the particular viscosity measurement method can cause some variations in measured results. However, the spirit of this description is not altered by using any consistent definitions of strain and anneal points, or any consistent viscosity measurement methods.

| | Lower Tg, Lower CTE Clad Layers | | | | | | | | | |
|---|---|---|---|---|---|---|---|---|---|---|
| Code | A | B | C | D | E | F | G | H | I | J |
| Soft. Pt. (° C.) | 806 | 776 | 820 | | 804 | 785 | 705 | 770 | 963 | 992 |
| Anneal Pt. (° C.) | 523 | 559 | 510 | 496 | 566 | 540 | 450 | 540 | 726 | 746 |
| Strain Pt. (° C.) | 483 | 512 | 458 | 456 | 519 | 497 | 408 | 515 | 674 | 691 |
| Density (g/cm³) | 2.18 | 2.23 | 2.16 | 2.13 | 2.26 | 2.24 | 2.16 | | 2.58 | 2.57 |
| CTE (×10⁷°/C) | 30 | 33 | 28 | 32 | 37 | 36.5 | 39.5 | 38.5 | 39 | 38.2 |
| Composition | | | | | | | | | | |
| (mol %) | | | | | | | | | | |
| SiO₂ | 80.4 | 83 | 81.8 | 71.8 | 81.6 | 80 | 68.3 | 78 | 59.7 | 60.8 |
| Al₂O₃ | 0.37 | 1.34 | 0 | 0 | 1.43 | 1.15 | 3.1 | 1.07 | 15.5 | 16.5 |
| B₂O₃ | 16.5 | 11.5 | 16.3 | 25.2 | 11.6 | 13.5 | 24.5 | 16.6 | 6.1 | 5.03 |
| Na₂O | 1.44 | 3.17 | 0 | 0 | 5.12 | 5.19 | 2.04 | 4.22 | 0 | 0 |
| K₂O | 1.31 | 0.76 | 1.83 | 0.42 | 0 | 0 | 0 | 1.16 | 0 | 0 |
| Li₂O | 0 | 0 | 0 | 2.57 | 0 | 0 | 2.11 | 0 | 0 | 0 |
| MgO | 0 | 0 | 0 | 0 | 0 | 0 | 0 | 0.49 | 2.46 | 1.85 |
| CaO | 0 | 0 | 0 | 0 | 0 | 0 | 0 | 0.5 | 4.54 | 4.26 |
| SrO | 0 | 0 | 0 | 0 | 0 | 0 | 0 | 0 | 4.11 | 5.07 |
| BaO | 0 | 0 | 0 | 0 | 0 | 0 | 0 | 0 | 7.13 | 6.17 |
| SnO₂ | 0 | 0 | 0 | 0 | 0 | 0 | 0 | 0 | 0.28 | 0.18 |
| As₂O₃ | 0 | 0.24 | 0 | 0 | 0 | 0 | 0 | 0 | 0 | 0 |
| Sb₂O₃ | 0 | 0.03 | 0 | 0 | 0 | 0 | 0 | 0 | 0 | 0 |
| TiO₂ | 0 | 0 | 0 | 0 | 0.01 | 0 | 0 | 0 | 0 | 0 |
| Cl | 0 | 0 | 0 | 0 | 0 | 0.17 | 0 | 0 | 0 | 0 |
| Fe₂O₃ | 0 | 0 | 0 | 0 | 0 | 0 | 0 | 0 | 0.024 | 0.024 |
| ZrO₂ | 0 | 0 | 0 | 0 | 0 | 0 | 0 | 0 | 0.005 | 0.004 |
| Total | 100 | 100 | 100 | 100 | ioo | 100 | 100 | 100 | 99.9 | 99.9 |
| Viscosity (P) | | | | | | | | | | |
| (below) | Tempeature at which viscosity occurs (° C.) | | | | | | | | | |
| 200 | | | | | | | | | | |
| 300 | | | | | | | | | | |
| 1000 | | | | 1342 | | 1400 | | | | |
| 10000 | | | 1300 | 1102 | | 1170 | 1175 | 1100 | | |
| 16000 | | | 1240 | | | | | 1080 | | |
| 35000 | | | 1180 | | | | | 1050 | | |
| 60000 | | | | | 1060 | | | | | |
| 100000 | | | 1115 | 939 | | 1030 | 980 | 990 | | |
| 120000 | | | | | | | | | | |
| 160000 | | 1050 | 1070 | | | | | 975 | | |
| 442000 | | | 1015 | | | | | | | |
| 1000000 | | | 980 | 832 | | | | 900 | | |
| 1500000 | | | | | | | | | | |
| 1600000 | 905 | | | | | | | | | |

| | Higher Tg, Higher CTE Core Layers | | | | | | |
|---|---|---|---|---|---|---|---|
| Code | K | L | M | N | O | P | Q |
| Soft. Pt. (° C.) | 898 | 844 | 900 | 988 | 894 | | 1043 |
| Anneal Pt. (° C.) | 675 | 609 | 652 | 644 | 625 | 637 | 807 |
| Strain Pt. (° C.) | 627 | 560 | 602 | 589 | 573 | 588 | 755 |
| Density (g/cm³) | 2.42 | 2.44 | 2.42 | 2.4 | 2.39 | 2.4 | 2.63 |
| CTE (×10⁷°/C) | 43.5 | 8.36 | 80 | 74.6 | 78.4 | 77.9 | 39.2 |
| Composition | | | | | | | |
| (mol %) | | | | | | | |
| SiO₂ | 61.5 | 69.2 | 68.8 | 67.4 | 64.7 | 70.5 | 63.2 |
| Al₂O₃ | 11.1 | 8.53 | 10.6 | 12.7 | 13.9 | 9.22 | 16.8 |
| B₂O₃ | 10 | 0 | 0 | 3.67 | 5.11 | 0 | 0 |
| Na₂O | 0 | 13.9 | 14.9 | 13.7 | 13.7 | 13.7 | 0 |
| K₂O | 2.43 | 1.17 | 0.02 | 0.02 | 0 | 0.01 | 0 |
| Li₂O | 0 | 0 | 0 | 0 | 0 | 0 | 0 |
| MgO | 6.39 | 6.45 | 5.43 | 2.36 | 2.38 | 5.27 | 3.5.2 |
| CaO | 8.46 | 0.54 | 0.04 | 0.01 | 0.14 | 1.12 | 4.53 |
| SrO | 0 | 0 | 0 | 0 | 0 | 0 | 1.57 |
| BaO | 0 | 0 | 0 | 0 | 0 | 0 | 9.87 |
| SnO₂ | 0.09 | 0.19 | 0.17 | 0.09 | 0.08 | 0.15 | 0 |
| As₂O₃ | 0 | 0 | 0 | 0 | 0 | 0 | 0 |
| Sb₂O₃ | 0 | 0 | 0 | 0 | 0 | 0 | 0 |
| TiO₂ | 0 | 0 | 0 | 0 | 0 | 0.01 | 0 |
| Cl | 0 | 0 | 0 | 0 | 0 | 0 | 0 |
| Fe₂O₃ | 0 | 0 | 0 | 0 | 0 | 0.01 | 0.11 |
| ZrO₂ | 0 | 0 | 0 | 0 | 0 | 0 | 0.05 |
| Total | 100 | 100 | 100 | 100 | 100 | 100 | 99.7 |

| Viscosity (P) | | | | | | |
|---|---|---|---|---|---|---|
| (below) | Tempeature at which viscosity occurs (° C.) | | | | | |
| 200 | | 1617 | 1643 | 1708 | 1660 | |
| 300 | | 1563 | 1589 | 1658 | 1613 | |
| 1000 | | 1424 | 1451 | 1525 | 1486 | 1480 |
| 10000 | | 1225 | 1254 | 1322 | 1295 | 1270 |
| 16000 | | 1192 | 1222 | 1287 | 1262 | 1250 |
| 35000 | | 1142 | 1172 | 1232 | 1211 | 1185 |
| 60000 | | | | | | |
| 100000 | | | | | | 1125 |
| 120000 | | | | | | |
| 160000 | | 1057 | 1090 | 1138 | 1124 | 1100 |
| 442000 | 1030 | | | | | |
| 1000000 | | | | | | |
| 1500000 | | 950 | | | | |
| 1600000 | | | | | | |

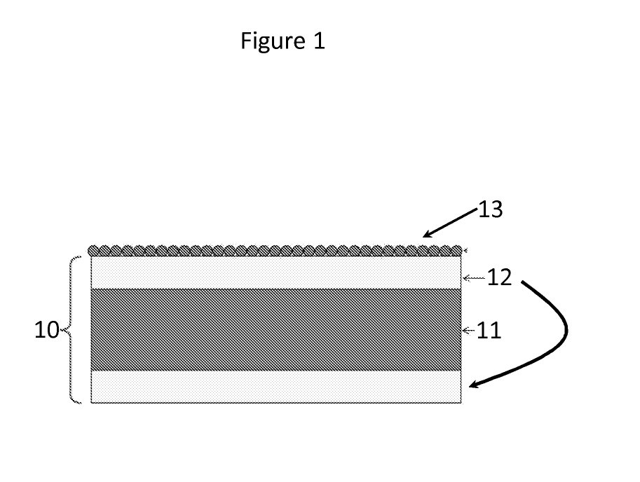

In some embodiments, the clad layers have a CTE lower than or about the same as the core layer of the laminate. In some embodiments, the clad layer has a CTE lower than the core layer of the laminate—placing the clad layers in compression upon cooling, thus strengthening the glass article. A glass laminate 10 according to embodiments hereof is schematically illustrated in FIG. 1, which is not drawn to scale. The glass laminate 10 includes a relatively high CTE core glass layer 11 and a relatively low CTE ion exchangeable clad glass layer 12 laminated to each surface of the core glass layer. As described in more detail hereinafter, the relatively low CTE clad glass layers are laminated to the relatively high CTE core glass layer by bonding the surfaces of the glass layers together at elevated temperatures such that the clad glass layers fuse to the core glass layers. The laminate is then allowed to cool. As the laminate cools, the relatively high CTE core glass layer 11 contracts more than the relatively low CTE clad glass layers 12 that are securely bonded to the surfaces of the core glass layer. Due to the variable contraction of the core glass layer and clad glass layers during cooling, the core glass layer is placed in a state of tension (or tensile stress) and the outer clad glass layers in a state of compression (or compressive stress). An advantageous, very deep depth of the compressive layer (or simply depth of layer or DOL) is thus formed in the laminate 10. Compressive stresses (or simply CS) at the surface of the glass in a range from about 50 MPa to about 400 MPa or 700 MPa may be achievable using lamination type strengthening.

According to an another embodiment, the clad glass layers 12 may extend beyond the edges of the core glass layer 11 and the edges of the clad glass layers may be bent into contact with each other and adhered or fused together (not shown). The edges of the core glass layer, which are in a state of tension, are encapsulated by the clad glass layers or layer, which are in a state of compression. Thus, the exposed surfaces of the laminate are all in a state of compression. Alternatively, one or more of the outer edges of the core glass layer 11 may extend beyond the corresponding outer edges of the clad glass layers 12, or the edges of the clad glass and the core glass layers may be coextensive.

In some embodiments, the glass clad can have a coefficient of thermal expansion (“CTE”) of about 25×10⁻⁷/° C. or greater, about 30×10⁻⁷/° C. or greater, about 35×10⁻⁷/° C. or greater, about 40×10⁻⁷/° C. or greater, about 45×10⁻⁷/° C. or greater, about 50×10⁻⁷/° C. or greater. In some embodiments, the CTE of the clad is from about 25×10⁻⁷ to about 50×10⁻⁷, about 25×10⁻⁷ to about 45×10⁻⁷, about 25×10⁻⁷ to about 40×10⁻⁷, about 25×10⁻⁷ to about 35×10⁻⁷, about 25×10⁻⁷ to about 30×10⁻⁷, about 30×10⁻⁷ to about 50×10⁻⁷, about 30×10⁻⁷ to about 45×10⁻⁷, about 30×10⁻⁷ to about 40×10⁻⁷, about 30×10⁻⁷ to about 35×10⁻⁷, about 35×10⁻⁷ to about 50×10⁻⁷, about 35×10⁻⁷ to about 45×10⁻⁷, about 35×10⁻⁷ to about 40×10⁻⁷, about 40×10⁻⁷ to about 50×10⁻⁷, about 40×10⁻⁷ to about 45×10⁻⁷, or about 45×10⁻⁷ to about 50×10⁻⁷/° C.

In some embodiments, the glass core can have a coefficient of thermal expansion of about 30×10⁻⁷/° C. or greater, about 35×10⁻⁷/° C. or greater, about 40×10⁻⁷/° C. or greater, about 45×10⁻⁷/° C. or greater, about 50×10⁻⁷/° C. or greater, about 55×10⁻⁷/° C. or greater, about 60×10⁻⁷/° C. or greater, about 65×10⁻⁷/° C. or greater, about 70×10⁻⁷/° C. or greater, about 75×10⁻⁷/° C. or greater, about 80×10⁻⁷/° C. or greater, about 85×10⁻⁷/° C. or greater, or about 90×10⁻⁷/° C. or greater. In some embodiments, the CTE of the core is from about 40×10⁻⁷ to about 100×10⁻⁷, about 50×10⁻⁷ to about 100×10⁻⁷, about 60×10⁻⁷ to about 100×10⁻⁷, about 70×10⁻⁷ to about 100×10⁻⁷, about 80×10⁻⁷ to about 100×10⁻⁷, about 90×10⁻⁷ to about 100×10⁻⁷, about 40×10⁻⁷ to about 90×10⁻⁷, about 50×10⁻⁷ to about 90×10⁻⁷, about 60×10⁻⁷ to about 90×10⁻⁷, about 70×10⁻⁷ to about 90×10⁻⁷, about 80×10⁻⁷ to about 90×10⁻⁷, about 40×10⁻⁷ to about 80×10⁻⁷, about 50×10⁻⁷ to about 80×10⁻⁷, about 60×10⁻⁷ to about 80×10⁻⁷, about 70×10⁻⁷ to about 80×10⁻⁷, about 40×10⁻⁷ to about 70×10⁻⁷, about 50×10⁻⁷ to about 70×10⁻⁷, or about 60×10⁻⁷ to about 70×10⁻⁷/° C.

The terms “relatively low CTE” or “low CTE” as used in relation to the clad glass in the present description and appended claims means a glass with a starting glass composition (e.g. prior to drawing, laminating and ion exchange) having a CTE that is lower than the CTE of the starting composition of the core glass by at least about 10×10⁻⁷/° C. The CTE of the clad glass may also be lower than the CTE of the core glass by an amount in a range from about 10×10⁻⁷/° C. to about 70×10⁻⁷/° C., from about 10×10⁻⁷/° C. to about 60×10⁻⁷/° C., or from about 10×10⁻⁷/° C. to about 50×10⁻⁷/° C. For example, the core glass may have a CTE of about 100×10⁻⁷/° C. and the clad glass may have a CTE of about 50×10⁻⁷/° C., such that there is a difference of about 50×10⁻⁷/° C. between the CTE of the core glass and the clad glass.

In some embodiments, the core glass has a viscosity that is at least about 25× higher than the clad glass at temperatures near the Tg or annealing point of the clad glass. In other embodiments, the viscosity of the core glass may be at least about 2×, 5×, 10×, or 20× the viscosity of the clad glass at temperatures near the Tg or annealing point of the clad glass.

In the case of fusion-formed glass compositions, the mismatch of the softening temperature or annealing temperature of the core and clad glass does not necessarily mean that the viscosities of the two glasses will be mismatched at the fusion forming and laminating temperatures. Thus, in some embodiments, it is desirable for the core and clad glasses to have a more closely matched viscosity at the fusion forming and laminating temperatures, relative to a larger mismatch in viscosity between the core and clad glasses at temperatures near their softening points or annealing points. For example, preferred glass laminate pairs may consist of a core layer having a viscosity which is at least 2× higher than the clad layers at temperatures near the annealing point of the clad layers, but where the same core-clad combination has a viscosity difference of no more than 1.5× at temperatures near the fusion forming temperature. Alternately, the viscosities of the core and clad can differ by more than 5× at temperatures near the clad annealing point, while the viscosities of the same pair differ by less than 2× at higher temperatures closer to those used during fusion forming. One embodied glass combination that meets this criteria from Table 1 is Glass B (clad layers) combined with Glass L (core layers). In another embodiment, the viscosities of the core and clad glass can differ by 10× or more near the clad annealing temperature, but the viscosities can differ by no more than 5× at higher (forming) temperatures.

In some embodiments, the clad layers may actually have a higher viscosity than the core layers at the forming or laminating temperature, but the clad layers may have a lower viscosity than the core layers near their annealing temperature. An example combination in this case would be Glass code C (clad layers) combined with Glass code L or Glass code M (core layers). Such a combination is acceptable or may even be preferred in some cases. Depending on melt geometry, a higher-viscosity clad or outer layer during melting and forming can constrain a lower-viscosity core layer and maintain the desired article shape during forming (e.g. laminate fusion forming), even if the core layer viscosity is somewhat lower during forming than what would ordinarily be considered ideal.

Example embodiments of clad and core compositions are illustrated in Table 1. While embodied compositions and component amounts are provided in more detail below, in some embodiments, clad compositions can comprise (in mol %): 65-85% SiO₂, 0-5% Al₂O₃, 8-30% B₂O₃, 0-8% Na₂O, 0-5% K₂O, and 0-5% Li₂O, with total R₂O (alkali) being less than 10 mol % along with various other additives, such as fining agents. Similarly, core compositions may for example comprise: 55-75% SiO₂, 2-15% Al₂O₃, 0-12% B₂O₃, 0-18% Na₂O, 0-5% K₂O, 0-8% MgO, and 0-10% CaO, with the total mol % (combined) of Na₂O, K₂O, MgO, and CaO being at least about 10 mol %.

One preferred family of clad glasses include alkali borosilicates. Boron is known to reduce the softening and annealing temperatures of these glasses, while retaining low CTE. At the same time, these glasses can have medium to high silica content, which aids in maintaining low CTE. Some of these glasses are known to phase separate at elevated temperatures, which may be undesirable during melting and forming because of variability introduced by time-dependent viscosity. In some preferred alkali borosilicate clad compositions, phase separation can be suppressed by adding 0.2-5 mol % of Al₂O₃ to the glass.

As a result of the raw materials and/or equipment used to produce the glass composition of the present invention, certain impurities or components that are not intentionally added, can be present in the final glass composition. Such materials are present in the glass composition in minor amounts and are referred to herein as “tramp materials.”

As used herein, a glass composition having 0 mol % of a compound is defined as meaning that the compound, molecule, or element was not purposefully added to the composition, but the composition may still comprise the compound, typically in tramp or trace amounts. Similarly, “sodium-free,” “alkali-free,” “potassium-free” or the like are defined to mean that the compound, molecule, or element was not purposefully added to the composition, but the composition may still comprise sodium, alkali, or potassium, but in approximately tramp or trace amounts.

SiO₂, an oxide involved in the formation of glass, functions to stabilize the networking structure of glass. In some embodiments, the glass clad comprises from about 50 to about 85 mol % SiO₂. In some embodiments, the glass clad comprises from about 58 to about 83 mol % SiO₂. In some embodiments, the glass clad can comprise from about 50 to about 85 mol %, about 50 to about 83 mol %, about 50 to about 80 mol %, about 50 to about 75 mol %, about 50 to 70 mol %, about 50 to 65 mol %, 50 to about 60 mol %, about 50 to about 55 mol %, about 55 to about 85 mol %, about 55 to about 83 mol %, about 55 to about 80 mol %, about 55 to about 75 mol %, about 55 to about 70 mol %, about 55 to about 65 mol %, about 55 to about 60 mol %, about 58 to about 85 mol %, about 58 to about 83 mol %, about 58 to about 80 mol %, about 58 to about 75 mol %, about 58 to about 70 mol %, about 58 to about 65 mol %, about 58 to about 60 mol %, about 60 to about 85 mol %, about 60 to about 83 mol %, about 60 to about 80 mol %, about 60 to about 75 mol %, about 60 to about 70 mol %, about 60 to about 65 mol %, about 65 to about 85 mol %, about 65 to about 83 mol %, about 65 to about 80 mol %, about 65 to about 75 mol %, about 65 to about 70 mol %, about 70 to about 85 mol %, about 70 to about 83 mol %, about 70 to about 80 mol %, about 70 to about 75 mol %, about 75 to about 85 mol %, about 75 to about 83 mol %, about 75 to about 80 mol %, about 80 to about 85 mol %, about 80 to about 83 mol %, or about 83 to about 85 mol % SiO₂. In some embodiments, the glass clad comprises about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85 mol % SiO₂.

In some embodiments, the glass core comprises from about 50 to about 75 mol % SiO₂. In some embodiments, the glass core comprises from about 60 to about 71 mol % SiO₂. In some embodiments, the glass core can comprise from about 50 to about 75 mol %, about 50 to 71 mol %, about 50 to 65 mol %, 50 to about 60 mol %, about 50 to about 55 mol %, about 55 to about 75 mol %, about 55 to about 71 mol %, about 55 to about 65 mol %, about 55 to about 60 mol %, about 60 to about 75 mol %, about 60 to about 71 mol %, about 60 to about 65 mol %, about 65 to about 75 mol %, about 65 to about 71 mol %, or about 70 to about 75 mol %, SiO₂. In some embodiments, the glass core comprises about 50, 51, 52, 53, 54, 55, 56, 57, 58, 59, 60, 61, 62, 63, 64, 65, 66, 67, 68, 69, 70, 71, 72, 73, 74, or 75 mol % SiO₂.

Al₂O₃ may provide for a) maintaining the lowest possible liquidus temperature, b) lowering the expansion coefficient, or c) enhancing the strain point. In some embodiments, the glass clad can comprise from 0 to about 20 mol % Al₂O₃. In some embodiments, the glass clad can comprise from greater than 0 to about 20 mol % Al₂O₃. In some embodiments, the glass clad can comprise from 0 to 20 mol %, 0 to about 15 mol %, 0 to about 10 mol %, 0 to about 5 mol %, 0 to about 3 mol %, greater than 0 to 20 mol %, greater than 0 to about 15 mol %, greater than 0 to about 10 mol %, greater than 0 to about 5 mol %, greater than 0 to about 3 mol %, about 3 to about 20 mol %, about 3 to about 15 mol %, about 3 to about 10 mol %, about 3 to about 5 mol %, about 5 to about 20 mol %, about 5 to about 15 mol %, about 5 to about 10 mol %, about 10 to about 20 mol %, about 10 to about 15 mol %, or about 15 to about 20 mol % Al₂O₃. In some embodiments, the glass clad can comprise about 0, 1, 2, 3, 4, 5, 6, 7, 8, 9, 10, 11, 12, 13, 14, 15, 16, 17, 18, 19 or 20 mol % Al₂O₃.

In some embodiments, the glass core comprises from about 5 to about 20 mol % Al₂O₃. In some embodiments, the glass composition can comprise from about 9 to about 17 mol % Al₂O₃. In some embodiments, the glass core can comprise from about 5 to about 20 mol %, about 5 to about 17 mol %, about 5 to about 10 mol %, about 9 to about 20 mol %, about 9 to about 17 mol %, or about 15 to about 20 mol % Al₂O₃. In some embodiments, the glass core can comprise about 5, 6, 7, 8, 9, 10, 11, 12, 13, 14, 15, 16, 17, 18, 19 or 20 mol % Al₂O₃.

Like SiO₂ and Al₂O₃, B₂O₃ contributes to the formation of the glass network. Conventionally, B₂O₃ is added to a glass composition in order to decrease the viscosity of the glass composition. However, in some embodiments described herein, B₂O₃ works in conjunction with additions of K₂O and Al₂O₃ (when present) to increase the annealing point of the glass composition, increase the liquidus viscosity, and inhibit alkali mobility. Alternatively, in some embodiments, B₂O₃ can be used as a flux to soften glasses, making them easier to melt. B₂O₃ may also react with non-bridging oxygen atoms (NBOs), converting the NBOs to bridging oxygen atoms through the formation of BO₄ tetrahedra, which increases the toughness of the glass by minimizing the number of weak NBOs. B₂O₃ also lowers the hardness of the glass which, when coupled with the higher toughness, decreases the brittleness, thereby resulting in a mechanically durable glass, which can be advantageous. In some embodiments, the glass clad comprises from 0 to about 30 mol % B₂O₃. In some embodiments, the glass clad can comprise from about 5 to about 25 mol % B₂O₃. In some embodiments, the glass clad can comprise from 0 to about 30 mol %, 0 to 25 mol %, 0 to 20 mol %, 0 to about 15 mol %, 0 to about 10 mol %, 0 to about 5 mol %, about 5 to about 30 mol %, about 5 to about 25 mol %, about 5 to about 20 mol %, about 5 to about 15 mol %, about 5 to about 10 mol %, about 10 to about 25 mol %, about 10 to about 20 mol %, about 10 to about 15 mol %, about 15 to about 30 mol %, about 15 to about 25 mol %, about 15 to about 20 mol %, about 20 to about 30 mol %, about 20 to about 25 mol %, about 25 to about 30 mol %, or about 30 to about 35 mol %, B₂O₃. In some embodiments, the glass clad can comprise about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol % B₂O₃.

In some embodiments, the glass core comprises from 0 to about 20 mol % B₂O₃. In some embodiments, the glass core can comprise from about 5 to about 25 mol % B₂O₃. In some embodiments, the glass core can comprise from 0 to about 20 mol %, 0 to about 18 mol %, 0 to about 15 mol %, 0 to about 12 mol %, 0 to about 10 mol %, 0 to about 8 mol %, 0 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol % B₂O₃. In some embodiments, the glass core can comprise about 0, 1, 2, 3, 4, 5, 6, 7, 8, 9, 10, 11, 12, 13, 14, 15, 16, 17, 18, 19 or 20 mol % B₂O₃.

Since MgO, CaO and BaO are effective in decreasing the viscosity of glass at a higher temperature and enhancing the viscosity of glass at a lower temperature, they may be used for the improvement of the melting property and enhancement of the strain point. However, if excessive amounts of both MgO and CaO are used, there is an increasing trend toward phase separation and devitrification of the glass. As defined herein, RO comprises the mol % of MgO, CaO, SrO, and BaO. In some embodiments, the glass clad and glass core can independently comprise from 0 to about 40 mol % RO. In some embodiments, the glass clad and glass core can independently comprise from 0 to about 25 mol % RO. In some embodiments, the glass clad and glass core can independently comprise 0 to about 40 mol %, 0 to about 35 mol %, 0 to about 30 mol %, 0 to 25 mol %, 0 to 20 mol %, 0 to about 15 mol %, 0 to about 10 mol %, 0 to about 5 mol %, about 5 to about 40 mol %, about 5 to about 35 mol %, about 5 to about 30 mol %, about 5 to about 25 mol %, about 5 to about 20 mol %, about 5 to about 15 mol %, about 5 to about 10 mol %, about 10 to about 40 mol %, about 10 to about 35 mol %, about 10 to about 25 mol %, about 10 to about 20 mol %, about 10 to about 15 mol %, about 15 to about 40 mol %, about 15 to about 35 mol %, about 15 to about 30 mol %, about 15 to about 25 mol %, about 15 to about 20 mol %, about 20 to about 45 mol %, about 20 to about 40 mol %, about 20 to about 35 mol %, about 20 to about 30 mol %, about 20 to about 25 mol %, about 25 to about 40 mol %, about 25 to about 35 mol %, about 25 to about 30 mol %, about 30 to about 40 mol %, about 30 to about 35 mol %, or about 35 to about 40 mol % RO. In some embodiments, the glass clad and core can independently comprise about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 mol % RO.

In some embodiments, MgO can be added to the glass to reduce melting temperature, increase strain point, or adjust CTE when used in combination with other alkaline earth compounds (e.g., CaO, SrO, and BaO). In some embodiments, the glass clad and glass core can independently comprise from 0 to about 20 mol % MgO. In some embodiments, the glass clad and glass core can independently comprise greater than 0 to about 20 mol % MgO. In some embodiments, the glass clad and glass core can independently comprise from 0 to about 10 mol % MgO. In some embodiments, the glass clad and glass core can independently comprise from 0 to about 20 mol %, 0 to about 18 mol %, 0 to about 15 mol %, 0 to about 12 mol %, 0 to about 10 mol %, 0 to about 8 mol %, 0 to about 5 mol %, 0 to about 3 mol %, about 3 to about 20 mol %, about 3 to about 18 mol %, about 3 to about 15 mol %, about 3 to about 12 mol %, about 3 to about 10 mol %, about 3 to about 8 mol %, about 3 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol %, MgO. In some embodiments, the glass clad and glass core can independently comprise about 0, 1, 2, 3, 4, 5, 6, 7, 8, 9, 10, 11, 12, 13, 14, 15, 16, 17, 18, 19, or 20 mol % MgO.

In some embodiments, CaO can contribute to higher strain point, lower density, and lower melting temperature. More generally, it can be a component of certain possible devitrification phases, particularly anorthite (CaAl₂Si₂O₈), and this phase has complete solid solution with an analogous sodium phase, albite (NaAlSi₃O₈). CaO sources include limestone, an inexpensive material, so to the extent that volume and low cost are factors, in some embodiments it is can be useful to make the CaO content as high as can be reasonably achieved relative to other alkaline earth oxides. In some embodiments, the glass clad and glass core can independently comprise from 0 to about 20 mol % CaO. In some embodiments, the glass clad and glass core can independently comprise from 0 to about 10 mol % CaO. In some embodiments, the glass clad and glass core can independently comprise from greater than 0 to about 20 mol % CaO. In some embodiments, the glass clad and glass core can independently comprise from 0 to about 20 mol %, 0 to about 18 mol %, 0 to about 15 mol %, 0 to about 12 mol %, 0 to about 10 mol %, 0 to about 8 mol %, 0 to about 5 mol %, 0 to about 3 mol %, about 3 to about 20 mol %, about 3 to about 18 mol %, about 3 to about 15 mol %, about 3 to about 12 mol %, about 3 to about 10 mol %, about 3 to about 8 mol %, about 3 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol %, CaO. In some embodiments, the glass clad and glass core can independently comprise about 0, 1, 2, 3, 4, 5, 6, 7, 8, 9, 10, 11, 12, 13, 14, 15, 16, 17, 18, 19, or 20 mol % CaO.

In some embodiments, the glass clad and glass core can independently comprise 0 to 20 mol % SrO. SrO can contribute to higher coefficient of thermal expansion, and the relative proportion of SrO and CaO can be manipulated to improve liquidus temperature, and thus liquidus viscosity. In some embodiments, the glass clad and glass core can independently comprise from 0 to about 20 mol % SrO. In some embodiments, the glass clad and glass core can independently comprise from 0 to about 18 mol % SrO. In some embodiments, the glass clad and glass core can independently comprise from 0 to about 15 mol % SrO. In some embodiments, the glass clad and glass core can independently comprise from about to about 10 mol % SrO. In other embodiments, the glass clad and glass core can independently comprise greater than 0 to about 10 mol % SrO. In some embodiments, the glass clad and glass core can independently comprise from 0 to about 20 mol %, 0 to about 18 mol %, 0 to about 15 mol %, 0 to about 12 mol %, 0 to about 10 mol %, 0 to about 8 mol %, 0 to about 5 mol %, 0 to about 3 mol %, about 3 to about 20 mol %, about 3 to about 18 mol %, about 3 to about 15 mol %, about 3 to about 12 mol %, about 3 to about 10 mol %, about 3 to about 8 mol %, about 3 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol %, SrO. In some embodiments, the glass clad and glass core can independently comprise about 0, 1, 2, 3, 4, 5, 6, 7, 8, 9, 10, 11, 12, 13, 14, 15, 16, 17, 18, 19, or 20 mol % SrO.

In some embodiments, the glass clad and glass core can independently comprise from 0 to 20 mol % BaO. In some embodiments, the glass clad and glass core can independently comprise from >0 to 20 mol % BaO. In some embodiments, the glass clad and glass core can independently comprise from 0 to 10 mol % BaO. In some embodiments, the glass clad and glass core can independently comprise from 0 to about 20 mol %, 0 to about 18 mol %, 0 to about 15 mol %, 0 to about 12 mol %, 0 to about 10 mol %, 0 to about 8 mol %, 0 to about 5 mol %, 0 to about 3 mol %, about 3 to about 20 mol %, about 3 to about 18 mol %, about 3 to about 15 mol %, about 3 to about 12 mol %, about 3 to about 10 mol %, about 3 to about 8 mol %, about 3 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol %, BaO. In some embodiments, the glass clad and glass core can independently comprise about 0, 1, 2, 3, 4, 5, 6, 7, 8, 9, 10, 11, 12, 13, 14, 15, 16, 17, 18, 19, or 20 mol % BaO.

Generally, alkali cations can raise the CTE steeply, but also can lower the strain point and, depending upon how they are added, they can increase melting temperatures. The least effective alkali oxide for raising CTE is Li₂O, and the most effective alkali oxide for raising CTE is Cs₂O. In some embodiments, the glass clad can comprise from 0 to about 10 mol % M₂O, wherein M is one or more of the alkali cations Na, Li, K, Rb, and Cs. In some embodiments, M₂O of the glass clad can comprise only trace amounts of Na₂O. In some embodiments, M₂O of the glass clad can comprise only trace amounts of Na₂O and K₂O. In certain embodiments, the alkalis of the glass clad can be Li, K and Cs or combinations thereof. In some embodiments, the glass clad is substantially alkali free, for example, the content of alkali metal can be about 1 weight percent or less, 0.5 weight percent or less, 0.25 mol % or less, 0.1 mol % or less or 0.05 mol % or less. The glass clad, according to some embodiments, can be substantially free of intentionally added alkali cations, compounds, or metals. In some embodiments, the glass clad can comprises from 0 to about 10 mol %, 0 to about 9 mol %, 0 to about 8 mol %, 0 to about 7 mol %, 0 to about 6 mol %, 0 to about 5 mol %, 0 to about 4 mol %, 0 to about 3 mol %, 0 to about 2 mol %, 0 to about 1 mol %, about 1 to about 10 mol %, about 1 to about 9 mol %, about 1 to about 8 mol %, about 1 to about 7 mol %, about 1 to about 6 mol %, about 1 to about 5 mol %, about 1 to about 4 mol %, about 1 to about 3 mol %, about 1 to about 2 mol %, about 2 to about 10 mol %, about 2 to about 9 mol %, about 2 to about 8 mol %, about 2 to about 7 mol %, about 2 to about 6 mol %, about 2 to about 5 mol %, about 2 to about 4 mol %, about 2 to about 3 mol %, about 3 to about 10 mol %, about 3 to about 9 mol %, about 3 to about 8 mol %, about 3 to about 7 mol %, about 3 to about 6 mol %, about 3 to about 5 mol %, about 3 to about 4 mol %, about 4 to about 10 mol %, about 4 to about 9 mol %, about 4 to about 8 mol %, about 4 to about 7 mol %, about 4 to about 6 mol %, about 4 to about 5 mol %, about 5 to about 10 mol %, about 5 to about 9 mol %, about 5 to about 8 mol %, about 5 to about 7 mol %, about 5 to about 6 mol %, about 6 to about 10 mol %, about 6 to about 9 mol %, about 6 to about 8 mol %, about 6 to about 7 mol %, about 7 to about 10 mol %, about 7 to about 9 mol %, about 7 to about 8 mol %, about 8 to about 10 mol %, about 8 to about 9 mol %, or about 9 to about 10 mol % M₂O. In some embodiments, the glass clad can comprise about 0, 1, 2, 3, 4, 5, 6, 7, 8, 9 or 10 mol % M₂O.

In some embodiments, the glass core can comprise from 0 to about 20 mol % M₂O, wherein M is one or more of the alkali cations Na, Li, K, Rb, and Cs. In some embodiments, the glass core can comprise from >0 to 20 mol % M₂O. In some embodiments, the glass core can comprise from 0 to 10 mol % M₂O. In some embodiments, M₂O of the glass core can comprise only trace amounts of Na₂O. In some embodiments, M₂O of the glass core can comprise only trace amounts of Na₂O and K₂O. In certain embodiments, the alkalis of the glass core can be Li, K and Cs or combinations thereof. In some embodiments, the glass core is substantially alkali free, for example, the content of alkali metal can be about 1 weight percent or less, 0.5 weight percent or less, 0.25 mol % or less, 0.1 mol % or less or 0.05 mol % or less. The glass core, according to some embodiments, can be substantially free of intentionally added alkali cations, compounds, or metals. In some embodiments, the glass core can comprise from 0 to about 20 mol %, 0 to about 18 mol %, 0 to about 15 mol %, 0 to about 12 mol %, 0 to about 10 mol %, 0 to about 8 mol %, 0 to about 5 mol %, 0 to about 3 mol %, about 3 to about 20 mol %, about 3 to about 18 mol %, about 3 to about 15 mol %, about 3 to about 12 mol %, about 3 to about 10 mol %, about 3 to about 8 mol %, about 3 to about 5 mol %, about 5 to about 20 mol %, about 5 to about 18 mol %, about 5 to about 15 mol %, about 5 to about 12 mol %, about 5 to about 10 mol %, about 5 to about 8 mol %, about 8 to about 20 mol %, about 8 to about 18 mol %, about 8 to about 15 mol %, about 8 to about 12 mol %, about 8 to about 10 mol %, about 10 to about 20 mol %, about 10 to about 18 mol %, about 10 to about 15 mol %, about 10 to about 12 mol %, about 12 to about 20 mol %, about 12 to about 18 mol %, about 12 to about 15 mol %, about 15 to about 20 mol %, about 15 to about 18 mol %, or about 18 to about 20 mol %, M₂O. In some embodiments, the glass core can comprise about 0, 1, 2, 3, 4, 5, 6, 7, 8, 9, 10, 11, 12, 13, 14, 15, 16, 17, 18, 19, or 20 mol % M₂O.

As in the case of sodium, potassium is also an element or ion commonly found in standard soda-lime glass compositions. In some embodiments, the glass clad and core can independently comprise from 0 to about 10 mol % K₂O. In some embodiments, the glass clad and core can independently comprise from 0 to about 5 mol % K₂O. In some embodiments, the glass clad and core can independently comprise from 0 to about 10 mol %, 0 to about 9 mol %, 0 to about 8 mol %, 0 to about 7 mol %, 0 to about 6 mol %, 0 to about 5 mol %, 0 to about 4 mol %, 0 to about 3 mol %, 0 to about 2 mol %, 0 to about 1 mol %, about 1 to about 10 mol %, about 1 to about 9 mol %, about 1 to about 8 mol %, about 1 to about 7 mol %, about 1 to about 6 mol %, about 1 to about 5 mol %, about 1 to about 4 mol %, about 1 to about 3 mol %, about 1 to about 2 mol %, about 2 to about 10 mol %, about 2 to about 9 mol %, about 2 to about 8 mol %, about 2 to about 7 mol %, about 2 to about 6 mol %, about 2 to about 5 mol %, about 2 to about 4 mol %, about 2 to about 3 mol %, about 3 to about 10 mol %, about 3 to about 9 mol %, about 3 to about 8 mol %, about 3 to about 7 mol %, about 3 to about 6 mol %, about 3 to about 5 mol %, about 3 to about 4 mol %, about 4 to about 10 mol %, about 4 to about 9 mol %, about 4 to about 8 mol %, about 4 to about 7 mol %, about 4 to about 6 mol %, about 4 to about 5 mol %, about 5 to about 10 mol %, about 5 to about 9 mol %, about 5 to about 8 mol %, about 5 to about 7 mol %, about 5 to about 6 mol %, about 6 to about 10 mol %, about 6 to about 9 mol %, about 6 to about 8 mol %, about 6 to about 7 mol %, about 7 to about 10 mol %, about 7 to about 9 mol %, about 7 to about 8 mol %, about 8 to about 10 mol %, about 8 to about 9 mol %, or about 9 to about 10 mol % K₂O. In some embodiments, the glass clad and core can independently comprise about 0, 1, 2, 3, 4, 5, 6, 7, 8, 9 or 10 mol % K₂O.

Additional components can be incorporated into the glass compositions to provide additional benefits. For example, additional components can be added as fining agents (e.g., to facilitate removal of gaseous inclusions from melted batch materials used to produce the glass) and/or for other purposes. In some embodiments, the glass may comprise one or more compounds useful as ultraviolet radiation absorbers. In some embodiments, the glass clad and core can independently comprise 5 mol % or less TiO₂, MnO, ZnO, Nb₂O₅, MoO₃, Ta₂O₅, WO₃, ZrO₂, Y₂O₃, La₂O₃, HfO₂, CdO, SnO₂, Fe₂O₃, CeO₂, As₂O₃, Sb₂O₃, Cl, Br, or combinations thereof. In some embodiments, the glass clad and core can independently comprise from 0 to about 5 mol %, 0 to about 3 mol %, 0 to about 2 mol %, 0 to 1 mol %, 0 to 0.5 mol %, 0 to 0.1 mol %, or 0 to 0.05 mol % TiO₂, MnO, ZnO, Nb₂O₅, MoO₃, Ta₂O₅, WO₃, ZrO₂, Y₂O₃, La₂O₃, HfO₂, CdO, SnO₂, Fe₂O₃, CeO₂, As₂O₃, Sb₂O₃, Cl, Br, or combinations thereof.

The glass composition, according to some embodiments, (e.g., any of the glasses discussed above) can include F, Cl, or Br, for example, as in the case where the glasses comprise Cl and/or Br as fining agents.

In some embodiments, the glass can be substantially free of Sb₂O₃, As₂O₃, or combinations thereof. For example, the glass can comprise 0.05 weight percent or less of Sb₂O₃ or As₂O₃ or a combination thereof, the glass may comprise zero weight percent of Sb₂O₃ or As₂O₃ or a combination thereof, or the glass may be, for example, free of any intentionally added Sb₂O₃, As₂O₃, or combinations thereof.

The glasses, according to some embodiments, can further comprise contaminants typically found in commercially-prepared glass. In addition, or alternatively, a variety of other oxides (e.g., TiO₂, MnO, ZnO, Nb₂O₅, MoO₃, Ta₂O₅, WO₃, ZrO₂, Y₂O₃, La₂O₃, P₂O₅, and the like) may be added, albeit with adjustments to other glass components, without compromising the melting or forming characteristics of the glass composition. In those cases where the glasses, according to some embodiments, further include such other oxide(s), each of such other oxides are typically present in an amount not exceeding about 3 mol %, about 2 mol %, or about 1 mol %, and their total combined concentration is typically less than or equal to about 5 mol %, about 4 mol %, about 3 mol %, about 2 mol %, or about 1 mol %. In some circumstances, higher amounts can be used so long as the amounts used do not place the composition outside of the ranges described above. The glasses, according to some embodiments, can also include various contaminants associated with batch materials and/or introduced into the glass by the melting, fining, and/or forming equipment used to produce the glass (e.g., ZrO₂).

In some embodiments, compositions could include lead (Pb) to lower the softening or annealing temperature of the clad layers, however it is generally avoided because of environmental concerns.

In some embodiments described herein, the glass compositions are substantially free of heavy metals and compounds containing heavy metals. Glass compositions which are substantially free from heavy metals and compounds containing heavy metals may also be referred to as “SuperGreen” glass compositions The term “heavy metals,” as used herein, refers to Ba, As, Sb, Cd, and Pb.

Clad or core compositions can also include coloring agents or additives that absorb specific portions of the EM spectrum, such as UV or IR absorbing additives for sunglasses, car windows, and the like.

The glass clad and core compositions described herein have liquidus viscosities which renders them suitable for use in a fusion draw process and, in particular, for use in a fusion laminate process. In some embodiments, the liquidus viscosity is greater than or equal to about 250 kPoise. In some other embodiments, the liquidus viscosity may be greater than or equal to 350 kPoise or even greater than or equal to 500 kPoise. In some embodiments, the high liquidus viscosity values of the glass clad and core described herein are attributable to the combination of high SiO₂ content in conjunction with the high concentration of tetragonal boron due to excess alkali constituents (i.e., M₂O—Al₂O₃) in the glass composition.

The glass clad and core compositions described herein have a low liquidus temperature which, like the liquidus viscosity, renders the glass suitable for use in a fusion draw process and, in particular, in a fusion laminate process. A low liquidus temperature prevents devitrification of the glass during the fusion draw fusion. This ensures high-quality homogeneous glass and consistent flow behavior. In some embodiments, the glass clad has a liquidus temperature less than or equal to about 900° C. and the core has a liquidus temperature less than or equal to about 1050° C. In some other embodiments, the liquidus temperature of the core may be less than or equal to about 1000° C. or even less than or equal to about 950° C. In some embodiments, the liquidus temperature of the glass core may be less than or equal to 900° C. In some other embodiments, the liquidus temperature of the clad may be less than or equal to about 850° C. or even less than or equal to about 7500° C. In some other embodiments, the liquidus temperature of the clad may be less than or equal to about 700° C. or even less. The liquidus temperature of the glass composition generally decreases with increasing concentrations of B₂O₃, alkali oxides and/or alkaline earth oxides.

One aspect of the invention is the ability to create nano-textured surfaces at temperatures that are near (within 200° C.) of the Tg, annealing point, or softening point of the clad layer of the laminate. This enables both surface texturing and the maintenance of overall sheet shape using a higher-Tg, annealing point, or softening point core layer, since the texturing does not have to occur at such a high temperature that would cause even the core layer to soften significantly. Thus the laminated structures combine the benefits of surface nano-texturing with maintaining overall article shape, together with surface compression for article strength, and robust surface scratch resistance.

The nano-textured surface may be composed of nanoparticles or may be made by modification of the clad layer via a texturing process. Texturing, as used herein, may any process that modified the surface structure of the glass clad, such as contacting with a substrate or adhering nanoparticles to the glass clad. Substrates that can be contacted with the glass to form a nano-textured surface comprise, for example, metal and ceramic rollers with surface structures, and the like.

The term “nanoparticle” refers to a particle/component with an average diameter along the shortest axis of between about 1 and about 10,000 nm. Nanoparticles further comprise other nanoscale compositions, such as nanoclusters, nanopowders, nanocrystals, solid nanoparticles, nanotubes, quantum dots, nanofibers, nanowires, nanorods, nanoshells, fullerenes, and large-scale molecular components, such as polymers and dendrimers, and combinations thereof. Nanoparticles may comprise any material compatible with the embodiments, such as, but not limited to metal, glass, ceramic, inorganic or metal oxide, polymer, or organic molecules or combination thereof. In some embodiments, the nanoparticles comprise silica, alumina, zirconia, titania, or combinations thereof.

In some embodiments, the nanoparticulate layer comprises nanoparticles comprising glass, ceramic, glass ceramic, polymer, metal, metal oxide, metal sulfide, metal selenide, metal telluride, metal phosphate, inorganic composite, organic composite, inorganic/organic composite, or combinations thereof. In some embodiments, the nanoparticulate layer comprises nanoparticles comprising silica, alumina, zirconia, titania, or combinations thereof. In some embodiments, the nanoparticulate layer comprises nanoparticles and has an average thickness of about 5 nm to about 10,000 nm. In some embodiments, the nanoparticulate layer comprises nanoparticles and has an average thickness of about 5 nm to about 1000 nm.

The term “binder” refers to a material that may be used, at least in part, to bond the nanoparticulate layer to the glass clad. In some embodiments, a binder is used to adhere the nanoparticulate layer to the glass substrate. In some embodiments, the binder comprises an alkali silicate borate, or phosphate, but may comprise any material compatible with bonding the nanoparticulate layer to the support element in the embodiment in which it is used. For example, the binder may comprise a surfactant to improve coating properties. The nanoparticulate layer may be chemically, mechanically, or physically bonded to and/or embedded in the binder.

The nanoparticulate layer may be formed during the glass process or subsequent to the glass cooling. If done while the glass is hot, i.e., at, near or above the Tg, annealing temperature, strain point, or softening point, methods such as sintering or electrostatic deposition. An example of one embodied method of texturing the surface is to sinter silica, borosilicate, or other glass or inorganic nanoparticles to the surface of the laminate at temperatures near the annealing point of the clad glass layers. In experiments with non-laminated glasses, the silica nanoparticles can be effectively sintered to the surface of a glass at temperatures exceeding the annealing point of the glass, but generally well below (90° C. or more below) the softening point of the glass. These particles form a very strong bond to the surface of the glass through this heat-treatment, leading to a robust and durable textured surface.

The nanoparticulate layer may also be formed when the glass is in a state below the Tg, annealing temperature, strain point, or softening point and once formed, the glass can subsequently be heated to allow for adhesion of the nanoparticulate layer. In some embodiments, the formation of the nanoparticulate layer comprises dip coating, spin coating, slot coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching. In some embodiments, the thickness of the coating comprises a function of the coating speed. In some embodiments, the thickness comprises a function of the concentration of the nanoparticulate layer.

It has been shown that the use of nanoparticle-coated surfaces is beneficial for obtaining surfaces with low percent total reflection (≦1% from 450-650 nm) as an anti-reflection coating or, as an anti-fingerprint surface when modified with a perfluoropolyethersilane (e.g., Dow Corning DC2634) or fluoroalkylsilane (e.g., heptadecafluoro-1,1,2,2-tetrahydrodecyl)trimethoxysilane (C₈F₁₇(CH₂)₂Si(OMe)₃), Gelest) or hydrocarbonsilane (e.g. octadecyltrimethoxysilane, Gelest) coatings that are oleophobic (oil static contact angle >90°) superoleophobic (>150°), and hydrophobic (water static contact angle >90°) or superhydrophobic)(>150°. The term oleophobic refers to a surface having an oleic acid static contact angle 90° room temperature (22-25° C.). The term hydrophobic refers to surface having a water static contact angle 90° at room temperature (22-25° C.). In some embodiments, the contact angle is measured using a goniometer (e.g., Drop Shape Analyzer DSA100, Kruss GmbH, Germany) Other applications where it may be advantageous to use nanoparticles include photovoltaic surfaces, anti-microbial coatings and catalyst applications. The present embodiments augment the ability to use these unique surface properties in many novel applications by producing a structure that is durable and additionally, is ion exchangeable, allowing for surface strengthening procedures to be done subsequent to structure formation.

Examples of nanoparticles that may be used in embodiments, include, but are not limited to, commercially available silica nanoparticles range from 10-200 nm colloidal silica dispersions in isopropanol (Organosilicasol, Nissan Chemical, USA), 10-200 nm colloidal silica dispersions in water (SNOWTEX®, Nissan Chemical, USA), 100-500 nm colloidal silica dispersions in water (Corpuscular Inc.), alumina dispersions (DISPERAL®, DISPAL®, Sasol Germany GmbH and AERODISP®, Evonik Degussa, USA), Zirconia dispersions (NanoUse ZR, Nissan Chemical, USA), and titania dispersions (AERODISP®, VP Disp., Evonik Degussa, USA).

It should be understood that particle sizes of nanoparticles can be distributional properties. Further, in some embodiments, the nanoparticles may have different sizes or distributions or more than one size or distribution. Thus, a particular size can refer to an average particle diameter or radius which relates to the distribution of individual particle sizes. In some embodiments, the size of the nanoparticles used is dependent on the wavelength of the excitation source. In some embodiments, the size of the nanoparticles is dependent on the analyte. In some embodiments, the nanoparticles of the nanoparticulate layer have an average diameter from about 5 nm to about 10000 nm, from about 5 nm to about 7500 nm, from about 5 nm to about 5000 nm, from about 5 nm to about 2500 nm, from about 5 to about 2000, from about 5 to about 1500, from about 5 to about 1250, 5 nm to about 1000 nm, from about 5 nm to about 750 nm, from about 5 nm to about 500 nm, from about 5 nm to about 250 nm, from about 5 to about 200, from about 5 to about 150, from about 5 to about 125, from about 5 to about 100, from about 5 to about 75, from about 5 to about 50, from about 5 to about 25, from about 5 to about 20, from about 10 nm to about 1000 nm, from about 10 nm to about 750 nm, from about 10 nm to about 500 nm, from about 10 nm to about 250 nm, from about 10 to about 200, from about 10 to about 150, from about 10 to about 125, from about 10 to about 100, from about 10 to about 75, from about 10 to about 50, from about 10 to about 25, from about 10 to about 20, from about 20 nm to about 1000 nm, from about 20 nm to about 750 nm, from about 20 nm to about 500 nm, from about 20 nm to about 250 nm, from about 20 to about 200, from about 20 to about 150, from about 20 to about 125, from about 20 to about 100, from about 20 to about 75, from about 20 to about 50, from about 20 to about 25, from about 50 nm to about 1000 nm, from about 50 nm to about 750 nm, from about 50 nm to about 500 nm, from about 50 nm to about 250 nm, from about 50 to about 200, from about 50 to about 150, from about 50 to about 125, from about 50 to about 100, from about 50 to about 75, from about 100 nm to about 1000 nm, from about 100 nm to about 750 nm, from about 100 nm to about 500 nm, from about 100 nm to about 250 nm, from about 100 to about 200, from about 100 to about 150, or about 5 nm, 10 nm, 20 nm, 25 nm, 50 nm, 75 nm, 100 nm, 125 nm, 150 nm, 175 nm, 200 nm, 250 nm, 300 nm, 400 nm, 500 nm, 600 nm, 700 nm, 750 nm, 800 nm, 900 nm, 1000 nm, 1250 nm, 1500 nm, 2000 nm, 2500 nm, 5000 nm, 7500 nm, or 10,000 nm.

In some embodiments, the roughness of the nanoparticulate layer is controlled via nanoparticle morphology, size, packing pattern, and height. In some embodiments, the morphology of the nanoparticulate layer is integral to the desired properties of the structure. In some embodiments, the morphology comprises the surface roughness of the nanoparticulate layer. In some embodiments, surface roughness is described by the arithmetic average of absolute values of surface height, Rₐ. In some embodiments, surface roughness may be described by the root mean square of the surface height values, R_{q}. In some embodiments, surface roughness comprises the nanoparticle interstitial space, the curved regions created by multiple particles situated within close proximity to each other. In some embodiments, surface roughness comprises the interstitial space of the nanoparticles. In some embodiments, close proximity comprises within about 100, 75, 50, 25, 20, 15, 10, 8, 7, 6, 5, 4, 3, 2.5, 2, 1.5, 1, 0.75, 0.5, 0.25, or 0 radii of the average nanoparticle size along the shortest dimension.

The nanoparticulate layer may comprise any structural formation. In some embodiments, the nanoparticulate layer comprises from about a monolayer to multilayer of nanoparticles. In some embodiments, the nanoparticulate layer comprises about a monolayer of nanoparticles. In some embodiments, the nanoparticulate layer comprises multiple layers of nanoparticles. In some embodiments, the nanoparticulate layer is ordered, disordered, random, packed, for example close packed, or arranged, for example via surface modification. In some embodiments, the nanoparticulate layer comprises nanoparticles that are clustered, agglomerated or ordered into isolated groups. Generally, dense or close packing will provide more nanostructured sites per unit surface area than non-dense packing. The limits of the packing density are influenced by the particle size. In some embodiments, useful average peak-to-peak distances (measured from apex to apex of adjacent nanoparticles) range from about 15 nm to 15,000 nm for nanoparticle sizes ranging from about 10 nm to about 10,000 nm. In some embodiments, average peak-to-peak distances comprise about 15, 30, 50, 75, 100, 150, 200, 250, 300, 350, 400, 450, 500, 600, 700, 800, 900, or 1000 nm with particle sizes of about 15, 30, 50, 75, 100, 150, 200, 250, 300, 350, 400, 450, 500, 600, 700, 800, 900, or 1000 nm. In some embodiments, average peak to peak distances comprise about 100, 75, 50, 25, 20, 15, 10, 8, 7, 6, 5, 4, 3, 2.5, or 2 radii of the average nanoparticle size along the shortest dimension.

In some embodiments, nanoparticles are partially embedded in the laminate so as to secure, bond, or adhere the nanoparticles to the laminate. Alternatively, in some embodiments the step of bonding the nanoparticulate layer to the laminate further comprises partially filling spaces between the particles with a binder.

In some embodiments, a majority of the particles in the nanoparticulate layer have a portion of their volume above the surface of the clad they are disposed on. In some embodiments the portion is less than ¾ of the volume of the particle. In one embodiment, the portion is less than ⅔ of the volume of the particle, for example, less than ½, for example, less than ⅓. In some embodiments, the nanoparticulate layer is embedded to a depth less than about half (i.e., less than about 50%) of the diameter or major dimension of the nanoparticulate layer. In other embodiments, the depth is less than about three eighths (i.e., less than about 37.5%) of the diameter of the nanoparticulate layer. In still other embodiments, the depth is less than about one fourth (i.e., less than about 25%) of diameter of the nanoparticulate layer.

The glass laminate 10 of FIG. 1 may be ion exchanged in order to chemically strengthen the laminate by further increasing the compressive stress in the near surface regions of the ion exchangeable clad glass layers 12. Processes for ion exchanging glass can be found in, for example, U.S. Pat. No. 3,630,704, hereby incorporated by reference in its entirety. The ion exchange chemical strengthening process generates a stress profile in the near surface regions of the clad glass layers. The compressive stress created at the outer surfaces and near surface regions of the clad glass layers are comparable to or greater than what can be achieved by ion exchange chemical strengthening alone, while maintaining compression at depth of layer as is achievable by lamination strengthening alone, but is not achievable by ion exchange chemical strengthening alone.

By combining both lamination mechanical glass strengthening and ion exchange chemical glass strengthening in a single laminated glass, the deep compressive stress layer obtained with the CTE mismatch of the laminated glasses is coupled with the high surface compressive stress obtained with the chemical ion-exchange process. The resulting laminated glass has a higher combined compressive stress (CS) and/or depth of compressive stress layer (DOL) than can be achieved using either ion exchange chemical strengthening or lamination glass strengthening alone, and superior mechanical performance can be obtained. The compressive stress at the outer surface of the clad glass layers from lamination may be over 50 MPa, over 250 MPa, in a range of from about 50 MPa to about 400 MPa, from about 50 MPa to about 300 MPa, from about 250 MPa to about 600 MPa, or from about 100 MPa to about 300 MPa. The compressive stress CS from ion exchange (if any) in the outer surface region of the clad glass layers may be 200 MPA or greater, 300 MPA or greater, 400 MPa or greater, 500 MPa or greater, 600 MPa or greater, 700 MPa or greater, 900 MPa or greater or in a range from 200 MPa to about 1000 MPA, from 200 MPa to about 800 MPA, with a resulting surface compression or compressive stress CS as high as 700 MPa to 1 GPa after ion exchange (i.e. 300 MPa from lamination and 700 MPa from ion exchange).

Coating durability (also referred to as Crock Resistance) refers to the ability of the antireflective coating 110 to withstand repeated rubbing with a cloth. The Crock Resistance test is meant to mimic the physical contact between garments or fabrics with a touch screen device and to determine the durability of the coatings disposed on the substrate after such treatment.

A Crockmeter is a standard instrument that is used to determine the Crock resistance of a surface subjected to such rubbing. The Crockmeter subjects a glass slide to direct contact with a rubbing tip or “finger” mounted on the end of a weighted arm. The standard finger supplied with the Crockmeter is a 15 mm diameter solid acrylic rod. A clean piece of standard crocking cloth is mounted to this acrylic finger. The finger then rests on the sample with a pressure of 900 g and the arm is mechanically moved back and forth repeatedly across the sample in an attempt to observe a change in the durability/crock resistance. The Crockmeter used in the tests described herein is a motorized model that provides a uniform stroke rate of 60 revolutions per minute. The Crockmeter test is described in ASTM test procedure F1319-94, entitled “Standard Test Method for Determination of Abrasion and Smudge Resistance of Images Produced from Business Copy Products,” the contents of which are incorporated herein by reference in their entirety.

Crock resistance or durability of the coatings, surfaces, and substrates described herein is determined by optical (e.g., reflectance, haze, or transmittance) measurements after a specified number of wipes as defined by ASTM test procedure F1319-94. A “wipe” is defined as two strokes or one cycle, of the rubbing tip or finger. In one embodiment, the contact angle of the nano-textured layer described herein varies by less than about 20% after 100 wipes from an initial value measured before wiping. In some embodiments, after 1000 wipes the contact angle varies by less than about 20% from the initial value and, in other embodiments, after 5000 wipes the contact angle varies by less than about 20% from the initial value.

In some embodiments, the nano-textured layer has a scratch resistance or hardness ranging from HB up to 9H, as defined by ASTM test procedure D3363-05.

In some embodiments, the glass article and antireflective layer described herein above, when placed in front of a pixelated display comprising a plurality of pixels, exhibits no sparkle. Display “sparkle” or “dazzle” is a generally undesirable side effect that can occur when introducing light scattering surfaces into a pixelated display system such as, for example, a liquid crystal display (LCD), an organic light emitting diode (OLED) display, touch screen, or the like, and differs in type and origin from the type of “sparkle” or “speckle” that has been observed and characterized in projection or laser systems. Sparkle is associated with a very fine grainy appearance of the display, and may appear to have a shift in the pattern of the grains with changing viewing angle of the display. Display sparkle may be manifested as bright and dark or colored spots at approximately the pixel-level size scale.

The degree of sparkle may be characterized by the amount of transmission haze exhibited by the glass article and the antireflective layer As used herein, the term “haze” refers to the percentage of transmitted light scattered outside an angular cone of about ±2.5°, in accordance with ASTM procedure D1003. Accordingly, in some embodiments, the antireflective layer has a transmission haze of less than about 1%.

In embodiments described herein, the glass article can be used for a variety of applications including, for example, for cover glass or glass backplane applications in consumer or commercial electronic devices including, for example, LCD and LED displays, computer monitors, and automated teller machines (ATMs); for touch screen or touch sensor applications; for portable electronic devices including, for example, mobile telephones, personal media players, and tablet computers; for photovoltaic applications; for architectural glass applications; for automotive or vehicular glass applications; for commercial or household appliance applications; or for lighting applications including, for example, solid state lighting (e.g., luminaires for LED lamps).

### Examples

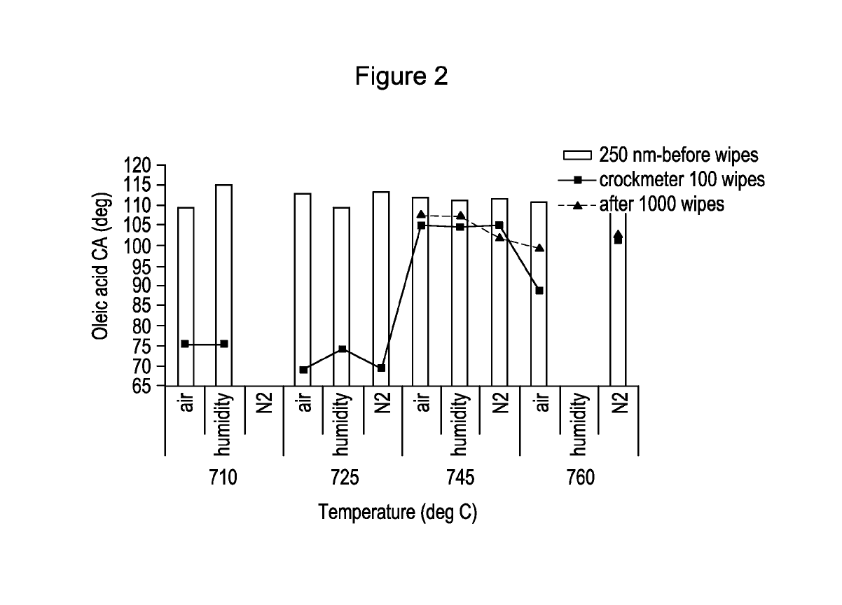

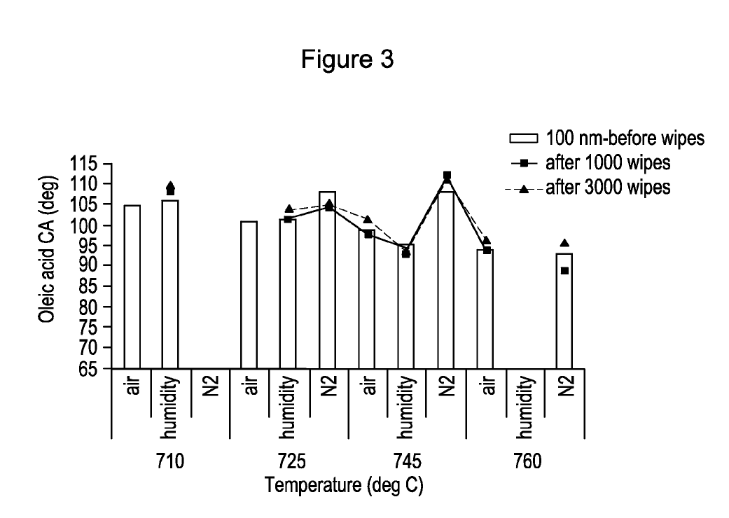

FIGS. 2 and 3 show data for 250 and 100 nm silica particles embedded on to a Glass code L glass surface using a heat treatment step. Glass code L has an annealing temperature of 609° C., Tg of 616° C., and a softening point of 844° C. Sintering temperature for each system was determined by running samples using temperatures in between anneal temperature and softening temperature, where each thermal treatment was carried out in air, N₂ and in N₂ with humidity for 1 hour. FIGS. 2 and 3 show the results of different thermal treatments carried out on the surface as a function of contact angle and durability. Here the measurement of liquid contact angle before and after wiping with a Crockmeter is used as an indicator of the robustness of the surface nano-texture durability.

In order to measure contact angle, the surfaces were coated with a low surface energy coating such as a fluorosilane. In this example, the requirement was to introduce nanotexture while improving the mechanical durability of the coating. Therefore, each of the surfaces was measured using oleic acid prior to the durability testing and is shown in a bar graph. Oleic acid contact angle on a flat fluorosilane coated surface is typically ˜70-80°. Higher oleic acid contact angles shown by 100 and 250 nm particles show the effect of the nanotexture created by the particles. The durability test performed on the sample was an ASTM standard crockmeter wipe test with a microfiber cloth using a ˜10 N force with crockmeter wipes of 100, 1000 and/or 3000. The decrease in contact angle)(>10° was used as an indicator for assessing lower durability. As seen from the FIGS. 2 and 3, temperature for the embedding of the nanoparticles with higher durability was typically >745° C. for 250 nm and >710° C. for 100 nm particles. Experiments showed that lower temperature was required to attach the smaller nanoparticle.

The experiments demonstrate that a sintering temperature of ˜95° C. above the Tg (˜100° C. above annealing temp., ˜130° C. below softening temp.) of the glass substrate was effective to strongly bond 100 nm SiO₂ particles to the glass surface, while a temperature of ˜130° C. above the Tg (˜135° C. above annealing temp., ˜100° C. below softening temp.) of the glass substrate was effective to strongly bond 250 nm SiO₂ particles to the glass surface. The experiments show the advantage of sintering particles to the surface of a laminated glass to create texture, where the sintering takes place at a temperature that is within 100° C., 150° C., or 200° C. of the Tg of the clad layers of the laminate, while the same sintering temperature is less than the Tg of the core layers of the laminate, or in other cases no more than 50° C. or 80° C. higher than the Tg of the core layers. Lower sintering temperatures with longer sintering times can also be employed to find an optimal treatment temperature.

In these experiments, humidity during sintering did not significantly improve particle adhesion. However, in other cases envisioned as being in the spirit of this invention, various surface treatments such as humid environments, basic or acidic treatments, leaching, ion-exchange treatments, surface grinding, etching, and the like can also be used to aid in the creation of surface texture, sintering, or surface softening.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass laminate comprising:
a glass core having a first Tg, annealing point strain point and a softening point;
a glass clad having a second Tg, annealing point, strain point and a softening point;
and optionally, a nanoparticulate layer;
wherein the glass clad comprises a nano-textured surface; and
wherein:
i. the Tg of the glass clad is lower than the Tg of the glass core;
ii. the annealing point of the glass clad is lower than the annealing point of the glass core; or
iii. the softening point of the glass clad is lower than the softening point of the glass core; and
wherein the CTE of the glass clad is lower than or equal to the CTE of the glass core.

2. The glass laminate of claim 1, wherein the temperature difference between the Tg of the glass clad and the glass core, between the annealing point of the glass clad and the glass core, or the softening point of the glass clad and the glass core is greater than 20° C.

3. The glass laminate of claim 2, wherein the temperature difference between the Tg of the glass clad and the glass core, between the annealing point of the glass clad and the glass core, or the softening point of the glass clad and the glass core is greater than 50° C.

4. The glass laminate of claim 3, wherein the temperature difference between the Tg of the glass clad and the glass core, between the annealing point of the glass clad and the glass core, or the softening point of the glass clad and the glass core is greater than 100° C.

5. The glass laminate of claim 4, wherein the temperature difference between the Tg of the glass clad and the glass core, between the annealing point of the glass clad and the glass core, or the softening point of the glass clad and the glass core is greater than 150° C.

6. The glass laminate of any of claim 1, wherein the strain point of the glass core is higher than or equal to the annealing point of the glass clad.

7. The glass laminate of any of claim 1, wherein the viscosity of the glass core is 2× or greater the viscosity of the glass clad at the Tg of the glass clad or the viscosity of the glass core is 2× or greater the viscosity of the glass clad at the annealing point of the glass clad.

8. The glass laminate of any of claim 1, wherein the viscosity of the glass core is 5× or greater the viscosity of the glass clad at the Tg of the glass clad or the viscosity of the glass core is 5× or greater the viscosity of the glass clad at the annealing point of the glass clad.

9. The glass laminate of any of claim 1, wherein the viscosity of the glass core is 10× or greater the viscosity of the glass clad at the Tg of the glass clad or the viscosity of the glass core is 10× or greater the viscosity of the glass clad at the annealing point of the glass clad.

10. The glass laminate of any of claim 1, wherein the viscosity of the glass core is 20× or greater the viscosity of the glass clad at the Tg of the glass clad or the viscosity of the glass core is 20× or greater the viscosity of the glass clad at the annealing point of the glass clad.

11. The glass laminate of any of claim 1, wherein
a ratio of the viscosity of the glass clad at the Tg of the glass clad to the viscosity of the glass core at the Tg of the glass clad gives a first ratio, R_{Tg};
a ratio of the viscosity of the glass clad at the forming temperature of the glass clad to the viscosity of the glass core at the forming temperature of the glass clad gives a second ratio, R_{F}; and
wherein the value of R_{Tg}/R_{F} from 1.1 to 3.0.

12. The glass laminate of any of claim 1, wherein
a ratio of the viscosity of the glass clad at the annealing point of the glass clad to the viscosity of the glass core at the annealing point of the glass clad gives a first ratio, R_{A};
a ratio of the viscosity of the glass clad at the forming temperature of the glass clad to the viscosity of the glass core at the forming temperature of the glass clad gives a second ratio, R_{F}; and
wherein the value of R_{A}/R_{F} from 1.1 to 3.0.

13. The glass laminate of any of claim 1, wherein the glass core comprises:
55-75% SiO₂
2-15% Al₂O₃
0-12% B₂O₃
0-18% Na₂O
0-5% K₂O
0-8% MgO and
0-10% CaO, and
wherein the total mol % (combined) of Na₂O, K₂O, MgO, and CaO is at least 10 mol %.

14. The glass laminate of any of claim 1, wherein the glass clad comprises:
0-5% Al₂O₃
8-30% B₂O₃
0-8% Na₂O
0-5% K₂O, and
0-5% Li₂O, and
wherein the total R₂O (alkali) is less than 10 mol %.

15. A method of forming the glass laminate of any of claim 1, comprising:
forming a glass laminate;
forming a nano-textured layer.

16. The method of claim 15, wherein the forming of the nano-textured layer is done at a temperature within 200° C. of the annealing point of the glass clad.

17. The method of claim 15, wherein the forming a nano-textured layer comprises sintering nanoparticles onto the glass clad.

18. The method of claim 17, wherein the nanoparticles have dimensions from about 50 nm to about 500 nm.

19. The method of any of claim 15, wherein the nano-textured layer comprises at least one nanoparticle selected from the group consisting of nanoclusters, nanopowders, nanocrystals, solid nanoparticles, nanotubes, quantum dots, nanofibers, nanowires, nanorods, nanoshells, fullerenes, large-scale molecular components, such as polymers and dendrimers, and combinations thereof.

20. The method of any of claim 15, wherein the nano-textured layer comprises nanoparticles comprising at least one material selected from the group consisting of glass, ceramic, glass ceramic, polymer, metal, metal oxide, metal sulfide, metal selenide, metal telluride, metal phosphate, inorganic composite, organic composite, inorganic/organic composite, and combinations thereof.

21. (canceled)
